(19) United States
(12) Patent Application Publication
(10) Pub. No.: US 2011/0289331 A1
(43) Pub. Date: Nov. 24, 2011

(54) STORAGE SYSTEM AND ITS INFORMATION PROCESSING METHOD

(75) Inventors: Naotaka Kobayashi, Odawara (JP); Koji Sonoda, Chigasaki (JP)

(73) Assignee: Hitachi, Ltd

(21) Appl. No.: 12/668,880

(22) PCT Filed: Jun. 30, 2009
(86) PCT No.: PCT/JP2009/062256

§ 371 Date: Jan. 12, 2010

(51) Int. Cl. G06F 1/32

(52) U.S. Cl. 713/323

(57) ABSTRACT

Returning a response to a host system in a range which does not cause time-out by the host system even if a disk device in a power saving status is an access target of the host system. A NAS controller determines an access request from a client terminal, outputs a command for spinning up a disk device in a spin off status to a disk controller if the access target includes shared folders corresponding with the disk devices in the spin off status, sends response information to the client terminal to the effect that processing for connection with the shared folder as the access target is being performed in response to the access request, and inhibits the client terminal from shifting to the time-out processing.

### TECHNICAL FIELD

This invention relates to technology of controlling the power saving of disk devices storing data in file systems.

### BACKGROUND ART

Needs for a file service using a NAS (Network Attached Storage) system including a file server for managing file systems and a disk array subsystem for storing data of file systems are rapidly increasing in recent years. In accordance with the above, the amount of data stored in the NAS system has increased, and the number of disk devices of the disk array system included in the NAS system is also of an increasing trend.

As the number of disk devices increases, every time each disk device is spun up to operate, the power consumption of the entire disk array system also increases. Therefore, in a large-capacity disk array system including a plurality of disk devices and configuring RAID (Redundant Array of Inexpensive Disks) of the plurality of disk devices, it is particularly necessary to inhibit the power consumption of the entire disk array system.

In this case, by stopping the rotation of the disk devices that are not accessed by the host systems for a certain length of time, the power consumption of the entire disk array system can be inhibited.

However, if frequently accessed data and seldom accessed data are stored in the same disk device, this disk device will be frequently accessed, which lowers the frequency of stopping the rotation, and the power consumption of the entire disk array system cannot be inhibited.

Meanwhile, if the length of time since the disk device is accessed until the rotation is stopped is set short for stopping the rotation of the disk device frequently, it is necessary to start the rotation (i.e. spin up) of the disk device each time the disk device is accessed, which may delay the response to the access.

Therefore, Patent Document 1 describes a system for saving power consumption while inhibiting the degradation of the response speed to accesses.

### RELATED ART DOCUMENTS

[Patent Document 1] Japanese Unexamined Patent Application Publication No. 2007-086843

### DISCLOSURE OF THE INVENTION

However, in conventional technologies, the inhibition of time-out occurring in a host system even if the host system sends an access request to the disk device in the spin-off status is not given sufficient consideration.

That is, as in the conventional technologies, if a logical volume is configured separately from a first logical volume for storing data of the disk devices whose rotation is stopped and a second logical volume for storing data of the files accessed with a higher frequency than a predetermined reference value, power consumption can be inhibited by stopping the rotation of the disk device for the accesses to the first logical volume, and degradation of the response time for the accesses in accordance with spin up can be prevented for the accesses to the second logical volume.

However, when giving consideration to reducing power consumption, for example, if all the disk devices whose access frequency has decreased are set to the spin off status, all the disk devices in the spin off status may become the access target of an access request from the host system. In this case, if a response is returned to the host system on condition that the disk devices in the spin off status are spun up and made accessible, the host system shifts to the time-out processing, and the access request is suspended.

Therefore, it is desired that, even if all the disk devices in the spin off status become the access targets, a response should be returned to the host system in the range time-out does not occur to the host system.

This invention was devised in view of the above-mentioned problems of the conventional technologies. Thus, an object of this invention is to provide a storage system and its information processing method capable of returning a response to the host system in the range time-out does not occur to the host system even if the disk device in the power saving status is the access target of the host system.

In order to achieve the foregoing object, this invention is characterized in that a primary controller for processing access requests from a host system distinguishes an access request from the host system and, if an access target designated in the access request includes a disk device in the power saving status, outputs to the disk controller a command for returning the disk device in the power saving status to the accessible status, and sends response information to the host system to the effect that processing for accessing the access target is being performed in response to the access request.

This invention enables the inhibition of time-out by the host system even if the disk device in the power saving status is the access target of the host system.

### BRIEF DESCRIPTION OF THE DRAWINGS

FIG. 1 is a diagram showing an example of the logical configuration of the NAS system according to this invention;

FIG. 2 is a diagram showing an example of the physical configuration of the NAS system according to this invention;

FIG. 3 is a diagram showing an example of the file system configuration information;

FIG. 4 is a diagram showing an example of the volume management information;

FIG. 5 is a diagram showing an example of the disk power saving control table;

FIG. 6 is a flowchart showing the processing in the NAS controller at the time of spin off;

FIG. 7 is a flowchart showing the other processing in the NAS controller at the time of spin up;

FIG. 8 is a flowchart showing the processing in the NAS controller at the time of spin up;

FIG. 9 is a flowchart showing the processing in the NAS controller when receiving a shared folder connection request; and

FIG. 10 is a flowchart showing the other processing in the NAS controller at the time of spin up.

### BEST MODE FOR CARRYING OUT THE INVENTION

The embodiments of this invention are now described with reference to the attached drawings. Note that the embodiments described below are merely exemplary of the invention and that this invention is not limited to the specific embodiments described below.

This embodiment explains a case of performing the file system service by using a NAS controller including the function as a file server, and a disk array system.

As more specifically described, this embodiment comprises a NAS controller which distinguishes an access request from a client terminal, and if an access target specified by the access request includes a disk device in the power saving status, outputs to the disk controller of the disk array system a command for returning the disk device in the power saving status to the accessible status, and sends the response information to the client terminal to the effect that the processing for accessing the access target is being performed until the disk device in the power saving status returns to the accessible status in response to the access request.

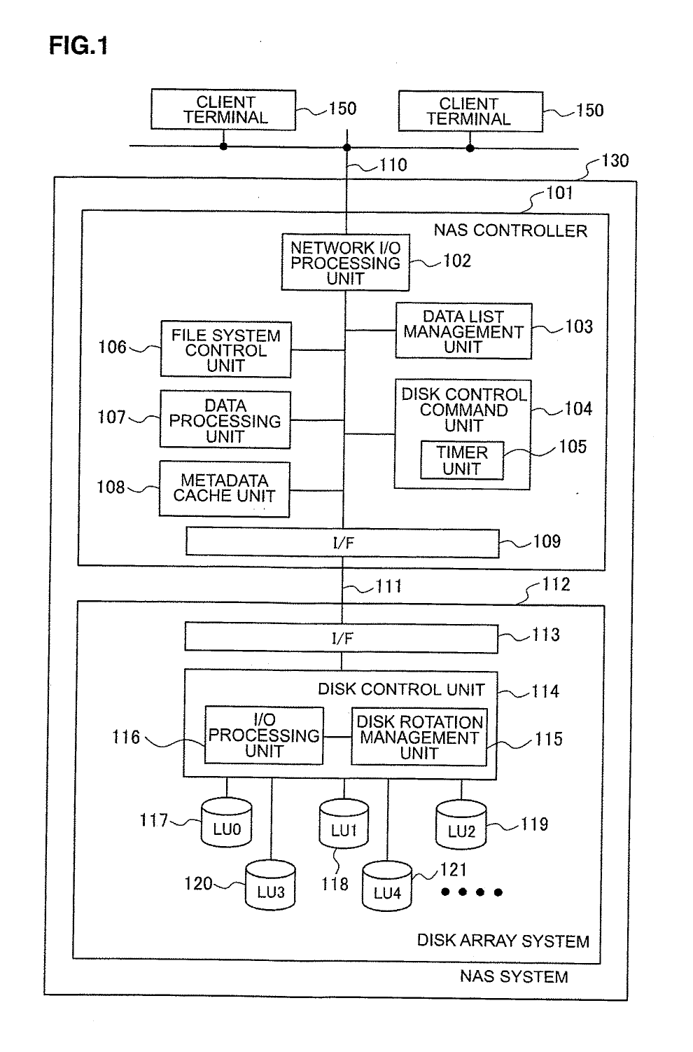

FIG. 1 is a diagram showing an example of the logical configuration of a NAS system in this embodiment. In FIG. 1, the NAS system 130 is a file sharing device and is configured as a storage system including a NAS controller 101 operating as a file server and a disk array system 112 for storing data of a file system.

The NAS controller 101 includes a network I/O processing unit 102, a data list management unit 103, a disk control command unit 104, a file system control unit 106, a data processing unit 107, a metadata cache unit 108, and an I/F (interface control unit) 109.

The NAS controller 101 is configured as a primary controller for exchanging information with a disk array system 112 via a SAN 111 as well as exchanging information with a client terminal 150 of a host system via an external network 110, and performing the processing for the client terminal 150 and the disk array system 112 with reference to the access request from the client terminal 150.

The network I/O processing unit 102 exchanges data with the client terminal 150, the management terminal, and other components via the external network 110. The data list management unit 103 manages various types of information such as, to be described later, file system configuration information 301, volume management information 401, and a disk power saving control table 501. The disk control command unit 104 includes a timer unit 105 for measuring the time and outputs commands for starting or stopping the rotation of the disk devices to the disk array system 112. The file system control unit 106 performs the file system related control such as a command for changing the files and directories to WORM (Write Once Read Many) and others. The data processing unit 107 performs data processing. The metadata cache unit 108 retains a copy of the metadata. The I/F 109 exchanges data with the I/F 113 included in the disk array system 112 via the communication path 111 such as a SAN (Storage Area Network).

In addition to the I/F (interface control unit) 113, the disk array system 112 includes the disk control unit 114 and a plurality of logical volumes (LU0 117, LU1 118, LU2 119, LU3 120, LU4 121, etc.). Note that the number of logical volumes is not limited to the example shown in FIG. 1. In the logical volumes LU0 117, LU1 118, LU2 119, LU3 120, and LU4 121, file data and data for various types of management of the file systems are stored.

The disk control unit 114 includes a disk rotation management unit 115 and an I/O processing unit 116. The I/O processing unit 116 reads and writes data from and to logical volumes, and the disk rotation management unit 115 controls the start, the stop, and the frequency of the disk rotation in the disk devices configuring logical volumes and others.

In this case, the disk rotation management unit 115, when controlling the start, the stop and the frequency of the disk rotation in the disk devices configuring the logical volumes, spins up the disk rotation until each disk device becomes accessible (e.g. until the disk rotation frequency becomes higher than in the standby status) or spins off the disk rotation until each disk device changes to the power saving status in which power consumption is smaller than in the accessible status; for example, until each disk is stopped.

Note that, when describing the start and the stop of the rotation of the disks included in the disk device, this description refers to the “rotation of the disk device,” which means the “rotation of the disks included in the disk device.”

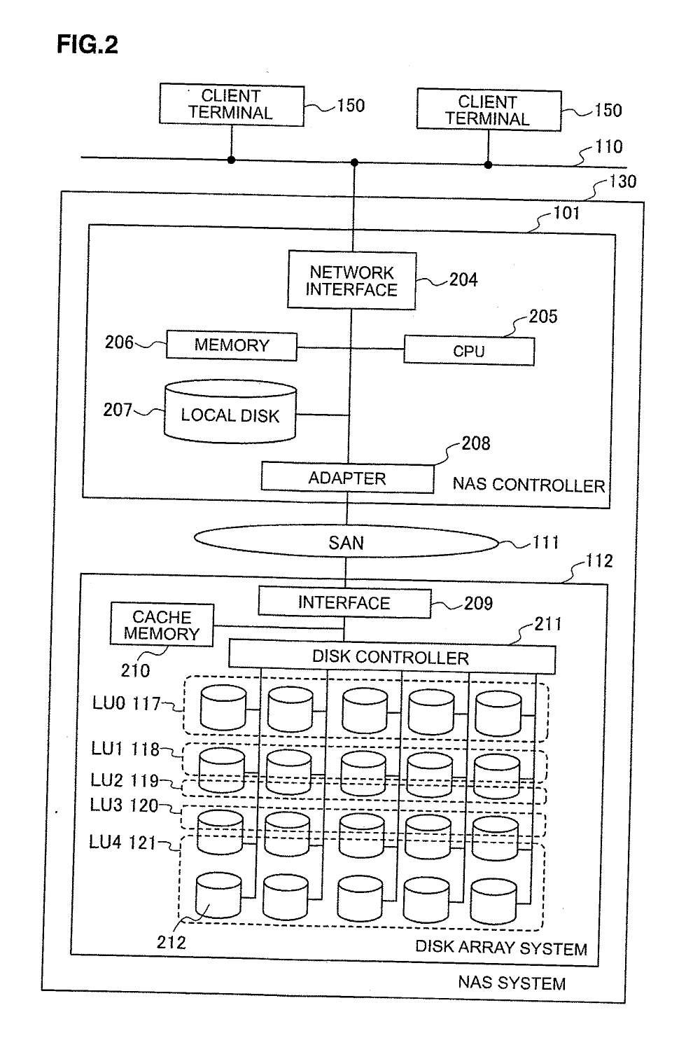

FIG. 2 is a diagram showing an example of the physical configuration of the NAS system in this embodiment.

The NAS controller 101 includes a network interface 204, a CPU (Central Processing Unit) 205, a memory 206, a local disk 207, and an adapter 208, and these are connected so as to be communicable with each other via an internal communication path.

The disk array system 112 includes an interface 209, a cache memory 210, a disk controller 211, and a plurality of disk devices 212 connected with the disk controller 211, and the interface 209, the cache memory 210, and the disk controller 211 are connected so as to be communicable with each other via an internal communication path.

The NAS controller 101 and the disk array system 112 are connected via the SAN 111. The connection method between the NAS controller 101 and the disk array system 112 is not limited to the SAN 111, and a private line or the TCP/IP (Transmission Control Protocol/Internet Protocol) Network and others may also be used.

The network interface 204 in the NAS controller 101 exchanges data with the external network 110. The local disk 207 stores various types of management data such as the programs to be executed by the NAS controller 101, file system configuration information 301, volume management information 401, a disk power saving control table 501, and others.

In the memory 206, various types of data and programs stored in the local disk 207 are read, and the temporary data for processing is stored.

The CPU 205 executes the processing to be performed by the NAS system 101. The adapter 208 exchanges data with the disk array system 112 via the SAN 111 or other networks.

Note that the data list management unit 103, the disk control command unit 104, the file system control unit 106, the data processing unit 107, and others are configured by the CPU 205 executing the programs read from the local disk 207 to the memory 206. Note that these programs may also be configured of one or more codes for causing the CPU 205 to perform various types of processing described later.

Furthermore, the metadata cache unit 108 shown in FIG. 1 may also be a part of the storage area in the memory 206, or another memory other than the memory 206 included in the NAS controller 101 may also be used as the metadata cache unit 108. Note that, if a non-volatile memory such as an NVRAM (Non Volatile Random Access Memory) is used as a memory configuring the metadata cache unit 108, the merit is that, even if the NAS controller 101 is rebooted due to a failure or other causes, it is not required to read the metadata from the disk array system 112 to the metadata cache unit 108 after the reboot because the metadata is stored in the non-volatile memory.

The interface 209 in the disk array system 112 exchanges data with the NAS controller 101 via the SAN 111 or other networks. The disk controller 211 controls data read/write and rotation for each disk device 212. The cache memory 210 temporarily retains the data which is read from or written to each disk device 212. Each disk device 212 includes one or more disks whose stop, start and frequency of rotation are controlled by the disk rotation management unit 115 shown in FIG. 1.

Note that a plurality of disk devices 212 are combined to configure a RAID group, and logical volumes are configured using a part of or the entire RAID group. The information on the correspondence of the disk devices 212 with the RAID group and the correspondence of the RAID group with the logical volumes belonging to this RAID group is managed in the memory included in the disk controller 211.

Furthermore, the disk controller 211 includes a memory and a CPU, and this memory stores an I/O processing program and a disk rotation management program to be executed by this CPU (not shown in the figure). The disk control unit 114 shown in FIG. 1 is configured by the CPU of the disk controller 211 performing the programs in the memory. Furthermore, the I/O processing unit 116 shown in FIG. 1 is configured by the CPU of the disk controller 211 performing the I/O processing program. The disk rotation management unit 115 is configured by the CPU of the disk controller 211 performing the disk rotation management program.

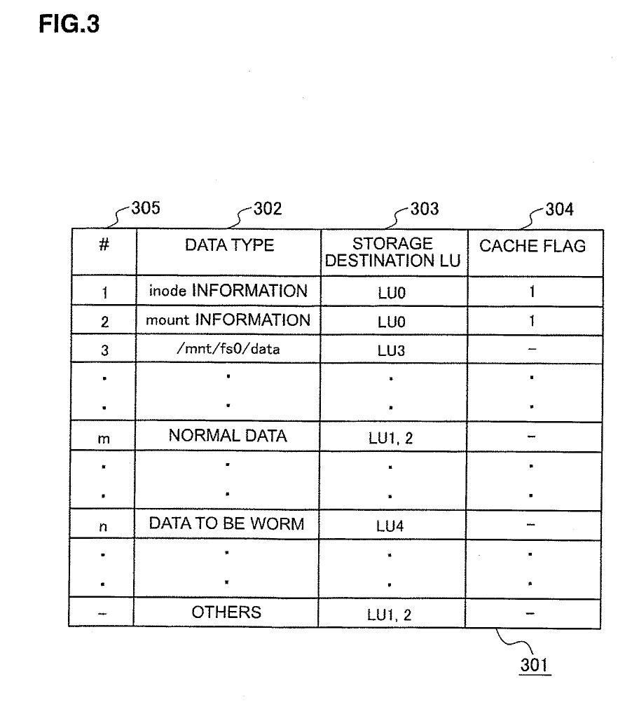

FIG. 3 is an example of the file system configuration information 301 managed by the data list management unit 103. The file system configuration information 301 includes an item number 305, a data type 302, a storage destination logical volume (hereinafter also referred to as an LU) 303, and a cache flag 304.

The data type 302 is information showing the type of data as the management target. For example, the item #1 shows that the data type is inode information (inode information is a type of metadata which is management data of the file system), and #2 shows that the data type is mount information which is a type of metadata. Furthermore, #3 shows that the data managed by #3 is managed in the hierarchy of mnt/fs0/or lower (i.e. the data of the file system identified by “fs0”). #m and #n show the data types with reference to the data attributes. #n shows that the data is of the WORM (Write Only Read Many) attribute described later while #m shows that the data is given another type of attribute (other than metadata and WORM attributes).

The storage destination LU 303 is information showing the LUs in the disk array system 112 in which the management target data is stored. The cache flag 304 shows whether the management target data should be cached in the metadata cache unit 108 of the NAS controller 101. Note that this embodiment shows that the management target data is cached in the metadata cache unit 108 if the cache flag 304 is “1” and that the data is not cached if the cache flag 304 is “0.” Furthermore, the NAS controller 101 does not have to include the metadata cache unit 108, and in this case, the file system configuration information 301 is not required to include the cache flag 304.

Note that the data types shown in FIG. 3 are merely exemplary, and other data types may also be registered in the file system configuration information 301, and all the data types shown in FIG. 3 are not required to be registered in the file system configuration information 301. The NAS controller 101 may also include a plurality of pieces of file system configuration information 301 in accordance with the types of the file system or other factors.

Furthermore, if it includes a plurality of file systems including files that are hierarchized in a plurality of logical volumes and installed, the NAS controller 101 can operate as a file server managing the plurality of file systems associated with a plurality of shared folders.

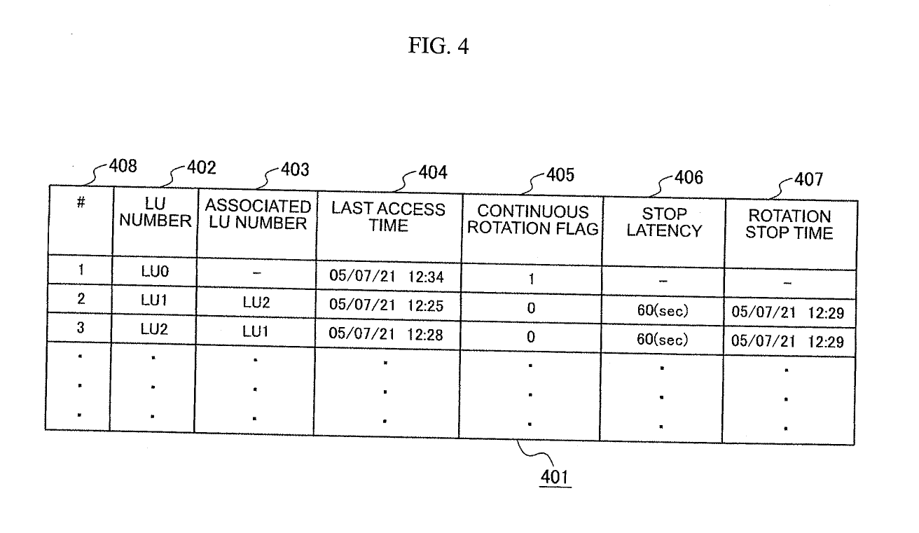

FIG. 4 is an example of the volume management information 401 managed by the data list management unit 103. The volume management information 401 includes an item number 408, an LU number 402, an associated LU number 403, a last access time 404, a continuous rotation flag 405, a stop latency 406, and a rotation stop time 407.

The LU number 402 is the identification information of logical volumes.

The associated LU number 403 is the identification information of the LUs (hereinafter referred to as associated LUs) sharing the disk device with the LUs identified by the corresponding LU numbers 402. That is, an associated LU is an LU belonging to the same RAID group as a specific LU, and the identification information of the associated LUs for the LUs identified by the corresponding LU numbers 402 is registered in the associated LU number 403. Therefore, for example, if the identification information of the LU1 118 in FIG. 2 is registered in the LU number 402, the identification information of the LU2 119 in FIG. 2 sharing the disk device with the LU1 118 is registered in the associated LU number 403.

Each time the relevant LU is accessed, the time measured by the timer unit 105 (i.e. the access time) is registered in the last access time 404. Therefore, the last access time 404 shows the time of the latest access to the relevant LU.

The continuous rotation flag 405 shows whether to perform the continuous rotation of the disk device configuring the relevant LU, and the setting to “1” shows that the continuous rotation of the disk device is performed regardless of the access frequency and the elapsed time after the last access time, while the setting to “0” shows that the rotation of the disk device might be stopped.

Note that the example in FIG. 4, as the continuous rotation flag 405 for the LU0 storing metadata is set to “1,” shows that the processing of stopping and resuming the rotation is not performed for the disk device configuring the LU0. Metadata is the management data of the file system showing where to store the files, directories and others in the disk array system 112. Therefore, the NAS controller 101, each time it receives an access request from the client terminal 150, must access metadata at first. Therefore, it may well be said that metadata is the data whose access frequency is predicted to be high in advance.

As for LUs storing such metadata, if the rotation of the disk device configuring an LU is stopped, spin up is required each time it is accessed, which causes latency for the spin up. As a result, the response time performance to the access request is deteriorated. Therefore, as for LUs storing data, such as metadata, whose access frequency is predicted to be high in advance, deterioration in the response time performance to the access request can be prevented by setting the continuous rotation flag 405 to “1.”

The setting method of the continuous rotation flag 405 shown in FIG. 4 is merely exemplary, and the continuous rotation flag 405 is not set to “1” only for LUs storing metadata. For example, for an LU storing the file data whose access frequency is predicted to be higher than the predetermined reference value, the administrator of the NAS system 130 may also set the continuous rotation flag 405 to “1” and, if the data processing unit 107 accumulates the statistical information of the access frequency to each LU and the access frequency reaches the predetermined reference value, it may also reset the continuous rotation flag 405 of the relevant LU to “1.”

If the value of the continuous rotation flag 405 is “0,” the stop latency 406 is set for the volume management information 401. The stop latency 406 is the value used for determining the timing to stop the rotation of the disk device and, when the length of time equal to the stop latency 406 elapses after the last access time 404, the processing of stopping the rotation of the disk device is performed. That is, if a longer period of time than this stop latency 406 elapses without any access to the relevant LU, the processing of stopping the rotation of the disk device configuring the relevant LU will be performed. If the rotation of the disk device is stopped, that time is set as the rotation stop time 407 for the volume management information 401.

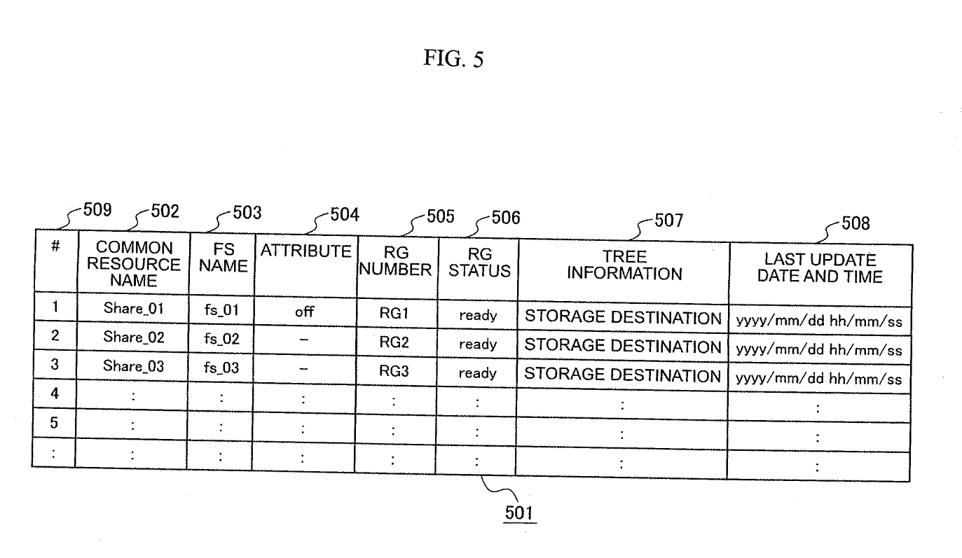

FIG. 5 is an example of the disk power saving control table 501 managed by the data list management unit 103. The disk power saving control table 501 includes an item number 509, a common resource name 502, an FS (File System) name 503, an attribute 504, an RG (RAID Group) number 505, an RG status 506, tree information 507, and a last update date and time 508.

The common resource name 502 is information for identifying common resource names published for the external network 110; for example, shared folder names. The FS name 503 is information for identifying the file system configured of disk devices. The attribute 504 shows whether the RG configuring the file system is entered as a power saving target. For example, it shows “off” if the entry is not reserved, and “-” if it is reserved as an entry.

The RG number 505 is the number of the RAID group configuring the file system. The RG status 506 shows whether the disk device belonging to the RAID group is spun up or spun down. For example, it shows “off” if the disk device belonging to the RAID group is spun off as a result of the power being turned off, and “ready” if it is spun up and in the accessible status.

The tree information 507 is information on the storage destination of tree information (e.g. directory configuring the file system and attribute information creating the file structure) on condition that the RG status 506 is “off.” The storage destination of the tree information is, for example, the metadata cache unit 108. The last update date and time 508 is the date and time (year, month, day, hour, minute, second) of the last access to the file system belonging to the RAID group. This last update date and time 508 is updated each time the file system is accessed.

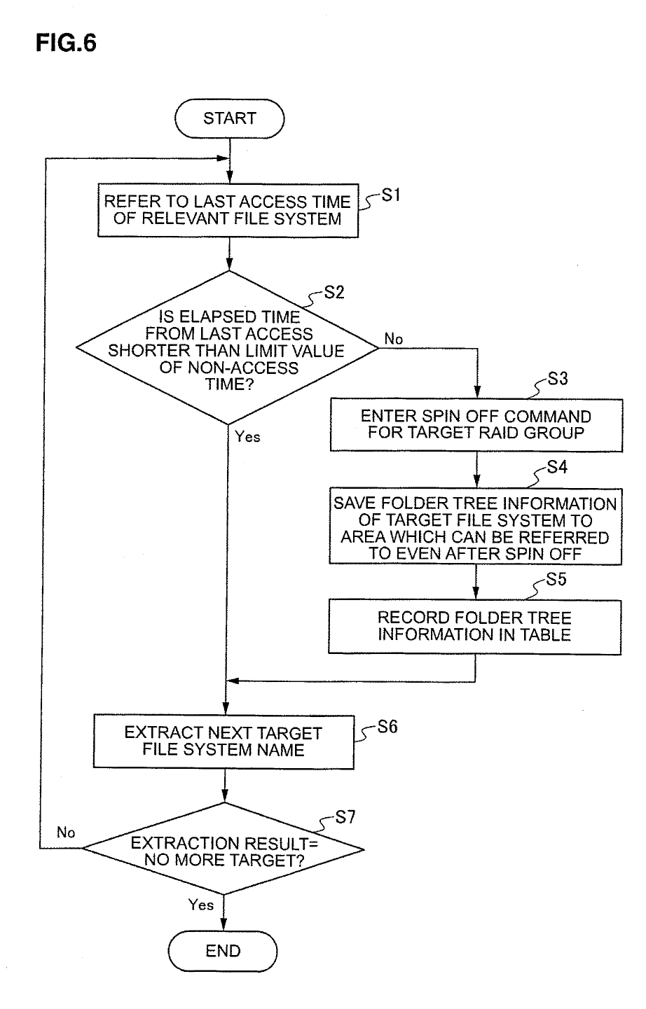

Next, the processing in the NAS controller at the time of spin off is described below with reference to the flowchart in FIG. 6.

Firstly, the NAS controller 101, for spinning off the disk device belonging to the file system, refers to the last update date and time 508 in the disk power saving control table 501 at an arbitrarily set frequency; for example, once an hour, retrieves the last access time of the file system as the target of power saving control (S1), and determines whether the elapsed time after the last access is shorter than the limit value of the non-access time; for example, whether or not it is shorter than one hour (S2).

At step S2, if the elapsed time after the last access is determined to be over the limit value, the NAS controller 101 enters the spin off command for the RAID group belonging to the file system as the power saving target, and records “off” in the attribute 504 in the disk power saving control table 501 (S3).

Next, the NAS controller 101 saves the tree information of the file system corresponding with the relevant RAID group; for example, folder tree information, to the area which can be referred to even after the spin off; for example, in the metadata cache unit 108 (S4), records the storage destination of the folder tree information in the tree information 507 in the disk power saving control table 501 (S5), and proceeds to the processing of step S6.

Meanwhile, at step S2, if the elapsed time after the last access is determined to be shorter than the limit value of the non-access time, the NAS controller 101 extracts the name of the next target file system (S6), and determines whether or not the processing related to the extracted target file system has been performed (S7).

The NAS controller 101, if it determines that the processing related to the target file system extracted at step S7 has not been performed, returns to step S1, repeats the steps from S1 to S7 for the next target file system or, if it determines at step 7 that the entire processing for the extracted file system has been completed, completes the processing of this routine.

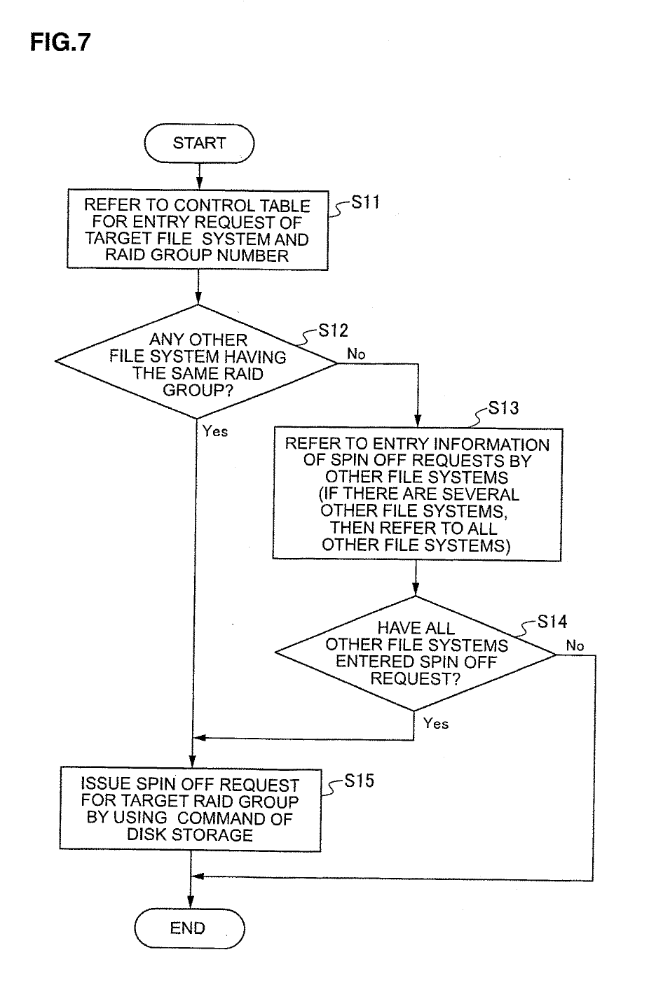

Next, the other processing in the NAS controller at the time of spin off is described below with reference to the flowchart in FIG. 7.

The NAS controller 101 starts the processing on condition that the spin off command related to the RAID group belonging to the file system as the target of power saving is entered, refers to the disk power saving control table 501 with reference to the file system name, retrieves the information of the attribute 504 as the entry request of the target file system as well as retrieve the information of the RG number 505 (S11), and determines whether or not there are any other file systems configuring the same RAID group (S12).

Next, the NAS controller 101, if it determines that there is any other file system configuring the same RAID group, refers to the attribute 504 of the other file system (S13). That is, if the same RAID group is configured of a plurality of file systems, it refers to the entry information of the spin off requests of the other file system, for ascertaining whether the spin off command is entered for the other file system. In this case, if there are a plurality of other file systems, the same number of pieces of information are referred to.

Subsequently, the NAS controller 101 determines whether all the other file systems have entered the spin off command (S14), and if they have not, as spin off is not performed without the entry, completes the processing of this routine or, if it determines that all the entries are completed, proceeds to the processing of step S15.

Meanwhile, the NAS controller 101, if it determines that there is no other file system configuring the same RAID group, issues the spin off request for spinning off the target RAID group to the disk controller 211 by using the command of the disk storage (S15), and completes the processing of this routine.

In this case, if the spin off request is issued to the disk controller 211, the disk rotation management unit 115 of the disk controller 211, assuming that the NAS controller 101 has ordered spin off, performs the power saving control for the disk device 212 belonging to the target RAID group, and changes the disk device 212 belonging to the target RAID group to the spin off status.

If the disk device 212 is changed to the spin off status and the rotation of the same is stopped, the information related to the disk device 212 in the spin off status is transferred from the disk control unit 114 to the NAS controller 101. By this processing, the data list management unit 103 of the NAS controller 101 updates the RG status 506 corresponding with the target RAID group in the disk power saving control table 501 from “ready” to “off.”

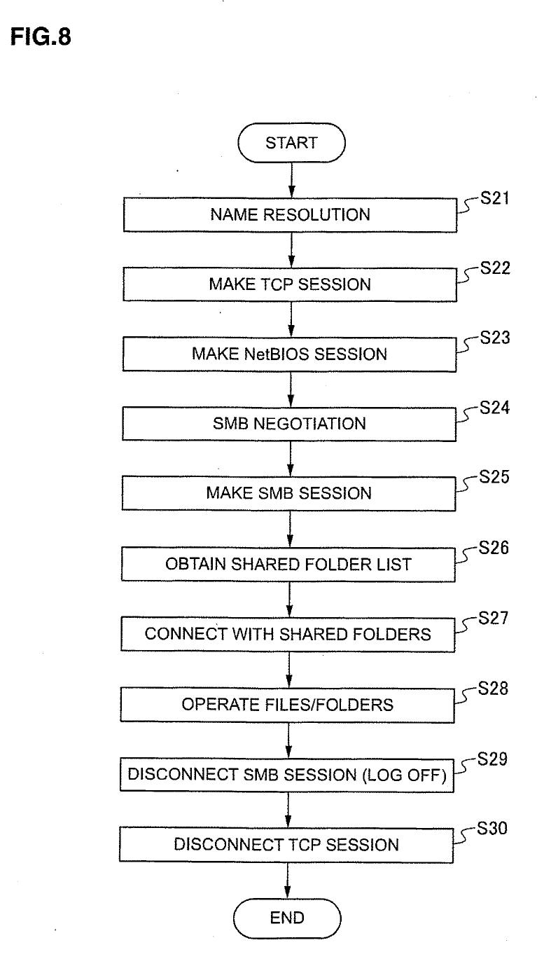

Next, the processing in the NAS controller 101 at the time of spin up is described below with reference to the flowchart in FIG. 8.

Firstly, the NAS controller 101, in response to the access request from the client terminal 150, performs addressing for specifying the communication target as a name resolution (S21), then performs the processing for making a TCP (Transmission Control Protocol) session (S22), and then performs the processing for making a NetBIOS (Basic Input Output System) session, that is, the processing for making a communication path (S23).

Next, the NAS controller 101 performs the SMB (Server Message Block) negotiation (S24), performs the processing for making the SMB session (S25), and obtains the list of the shared folders (S26). That is, the NAS controller 101 obtains the list of the shared folders published on the external network 110.

Subsequently, the NAS controller 101 performs the processing for connecting the client terminal 150 with the shared folders (S27). In this processing, if the disk device 212 belonging to the file system specified by the access request from the client terminal 150 is in the spin off status, the NAS controller 101 performs at least two round-trip packet transmissions with the client terminal 150.

That is, as it takes several minutes for the disk device 212 in the spin off status to be spun up and return to the accessible status, in that while, the NAS controller 101 will create a response information that the processing for making the disk device 212 in the spin off status accessible is performed with reference to the tree information saved in the metadata cache unit 108, and perform at least two packet transmissions for the purpose of adding the created response information to the command and responding to the client terminal 150.

As commands used for the two packet transmissions; for example, SMB_COM_TREE_CONNECT_ANDX and TRANS2_QUERY_PATH_INFORMATION are available.

At this time, if a delayed response by approximately fifty to fifty-five seconds per packet transmission is made using quasi response information added to the command, the two packet transmissions can gain a total of one hundred to one hundred and ten seconds. This time gaining enables the inhibition of the time-out processing by the client terminal 150.

That is, if the NAS controller 101 does not return any response from the client terminal 150 to the client terminal 150 while performing the processing for connecting the client terminal 150 with the shared folders, the client terminal 150 shifts to the time-out processing for terminating the access to the NAS controller 101 on condition that the time-out period has elapsed.

Therefore, while the disk device 212 in the spin off status is spun up and returns to the accessible status, the NAS controller 101 will perform at least two packet transmissions with the client terminal 150 so as to inhibit the client terminal 150 from terminating the access to the NAS controller 101 even if the timeout period has elapsed.

Next, the NAS controller 101, on condition that the disk device 212 in the spin off status was spun up and changed to the accessible status, for example, on condition that it has received the information that the disk device 212 in the spin off status was spun up and changed to the accessible status from the disk controller 211, as well as stopping the sending of the response information to the client terminal 150, performs the processing for operating the file or the folder (S28). That is, at this step, the processing for the disk control unit 114 to actually access the disk device 212 belonging to the shared folder selected with reference to the operation information form the client terminal 150 is performed.

Next, the NAS controller 101, on condition that it has obtained the information that the access to the disk device 212 is completed from the disk control unit 114, disconnects the SMB session (S29), disconnects the TCP session (S30), and completes the processing of this routine.

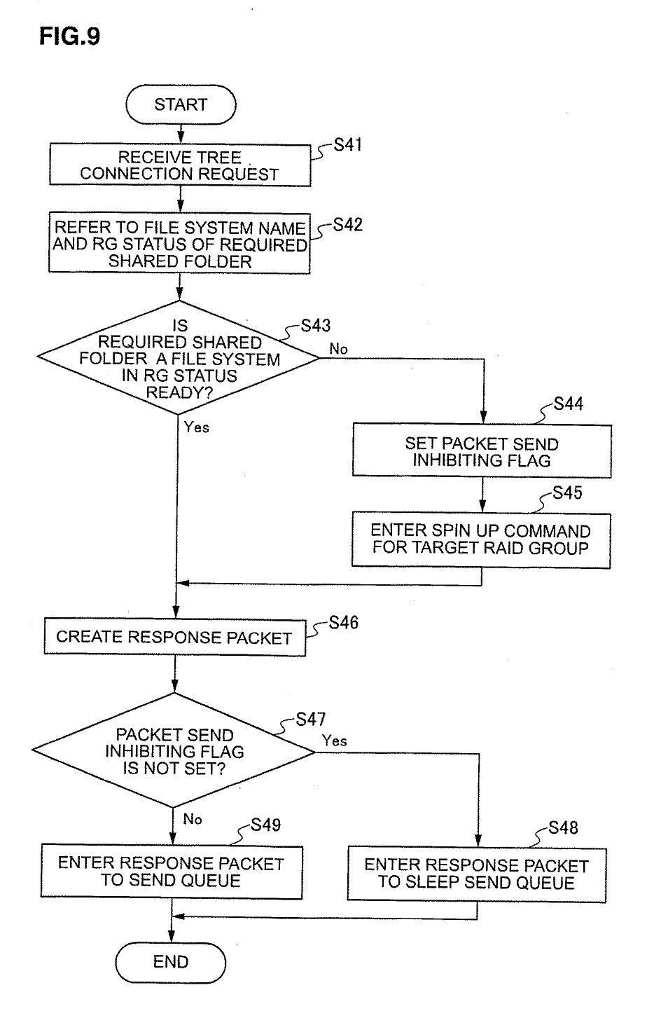

Next, the processing in the NAS controller when receiving a shared folder connection request is described below with reference to the flowchart in FIG. 9.

Firstly, the NAS controller 101 starts the processing when receiving the shared folder connection request from the client terminal 150 by smbd (server message block daemon), receives the tree connection request for a connection to the specified shared folder among a plurality of shared folders (S41), refers to the disk power saving control table 501 with reference to the received tree connection request, retrieves the information related to the file system name and the RG status 506 of the required shared folder (S42), and checks the RG status 506 with reference to the retrieved information (S43).

That is, at step S43, for determining whether or not the file system belonging to the required shared folder is in the spin up status, the NAS controller 101 determines whether “ready” exists in the RG status 506 corresponding with the file system belonging to the required shared folder. At step S43, if the RG status 506 is determined to be “off,” the NAS controller 101, assuming that the file system belonging to the required shared folder is in the spin off status, sets the packet transmission inhibiting flag (S44), enters the spin up command for spinning up the disk device 212 in the target RAID group including the file system belonging to the required shared folder (S45), and proceeds to the processing of step S46.

Meanwhile, at step S43, if “ready” is determined to exist in the RG status 506 corresponding with the file system belonging to the required shared folder, the NAS controller 101 proceeds to the processing of step S46, and creates a response packet at step S46.

Next, the NAS controller 101 confirms that the packet transmission inhibiting flag is not set for the required shared folder (S47) and, if it determines that the packet transmission inhibiting flag is set (Yes), enters the response packet to the sleep transmission queue (S48), and completes the processing of this routine.

Meanwhile, if it determines at step S47 that the packet transmission inhibiting transmission flag is set for the required shared folder (No), the NAS controller 101 enters the response packet to the transmission queue (S49), and completes the processing of this routine. Note that the sleep transmission queue will send the response packet automatically when the period of time set for the sleep timer (not shown in the figure) installed in the NAS controller 101 elapses.

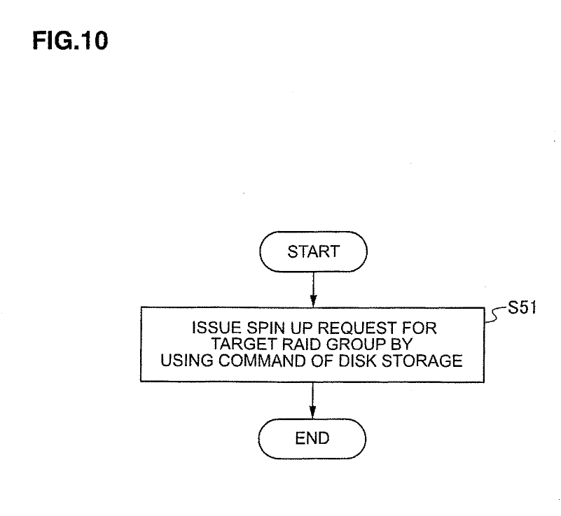

Next, the processing in the NAS controller at the time of spin up is described below with reference to the flowchart in FIG. 10.

Firstly, the NAS controller 101 starts the processing with reference to the file system name, issues a spin up request to the disk control unit 114 of the disk controller 211 for spinning up the disk device 212 belonging to the target RAID group by using the command of the disk storage (S51), and completes the processing of this routine.

In this case, the disk control unit 114, when receiving the spin up request, spins up the disk device 212 as the target of the spin up, keeps the rotation frequency as specified, and changes the device to the accessible status. Subsequently, the disk control unit 114 sends the information that the spin up of the disk device 212 is completed to the NAS controller 101.

By this method, the data list management unit 103 of the NAS controller 101 updates the RG status 506 corresponding with the RG including the disk device 212 as the target of the spin up from among the RG status 506 in the disk power saving control table 501 from “off” to “ready.” Furthermore, the NAS controller 101 reconnects the response packet from the sleep queue to the transmission queue, and immediately switches to the processing for publishing the response packet.

In this embodiment, as the NAS controller 101 will determine the access request from the client terminal 150, output the command (request) for spinning up the disk device in the spin off status to the disk controller 211 if the access target includes the shared folders corresponding with the disk devices in the spin off status, and send the response information that the processing for the connection with the shared folder as the access target is being performed in response to the access request to the client terminal 150 by at least two packet transmissions, it is possible to inhibit the client terminal 150 from shifting to the time-out processing.

According to this embodiment, even if the disk device in the power saving mode is the access target of the client terminal 150, time-out by the client terminal 150 can be inhibited.

Furthermore, this embodiment achieves the power saving control over the NAS system and a broader application of the power saving function of the disk array system.

### EXPLANATION OF REFERENCE NUMERALS

101: NAS controller
102: Network I/O processing unit
103: Data list management unit
104: Disk control command unit
105: Timer unit
106: File system control unit
107: Data processing unit
108: Metadata cache unit
109: I/F
110: External network
111: communication path
112: Disk array system
113: I/F
114: Disk control unit
115: Disk rotation management unit
150: Client terminal

1. A storage system, comprising:
a plurality of disk devices for storing data;
a disk controller for controlling the input and output of data to and from the plurality of disk devices and controlling the rotation of each disk as a constituent element of each of the disk devices so as to cause each of the disk devices to be in an accessible status or a power saving status; and
a primary controller for sending and receiving information to and from a host system and the disk controller, and executing processing to the disk controller and each of the disk devices based on an access request from the host system;
wherein the primary controller distinguishes an access request from the host system and, if an access target designated in the access request includes a disk device in the power saving status, outputs to the disk controller a command for returning the disk device in the power saving status to the accessible status, and sends response information to the host system to the effect that processing for accessing the access target is being performed in response to the access request.

2. The storage system according to claim 1, further comprising:
a plurality of logical volumes configured from a logical storage area of the plurality of disk devices; and
a plurality of file systems including a file group that was hierarchized and created on the plurality of logical volumes;
wherein the disk controller spins up the rotation of each of the disks until each of the disk devices becomes the accessible status or spins off the rotation of each of the disks until each of the disk devices becomes the power saving status;
wherein the primary controller functions as a file server for managing the plurality of file systems by associating them with a plurality of shared folders;
if a power saving-target file system exists in the plurality of file systems, the primary controller outputs to the disk controller a command for causing a disk device corresponding to the power saving-target file system to become the power saving status, and saves tree information of the power saving-target file system;
the primary controller distinguishes an access request from a client terminal as the host system and, if the access request is a connection request to a shared folder belonging to any file system among the plurality of file systems, extracts an access-target file system designated in the access request among the plurality of file systems;
if a disk that was subject to the spin-off is included in a disk device corresponding to the extracted target file system, the primary controller outputs to the disk controller a command for spinning up the spun-off disk;
the primary controller creates response information to the effect that connection processing is being performed to a shared folder belonging to the target file system based on the saved tree information, and sends the created response information to a client terminal as the host system until the connection processing that is being performed to the shared folder belonging to the target file system is complete; and
the primary controller stops sending the response information upon receiving information from the disk controller to the effect that the disk device in the power saving status has been returned to the accessible status.

3. The storage system according to claim 1,
wherein the disk controller spins up the rotation of each of the disks until each of the disk devices becomes the accessible status or spins off the rotation of each of the disks until each of the disk devices becomes the power saving status; and
wherein the primary controller distinguishes an access request from the host system and, if a disk device containing a disk that was subject to the spin-off is included in an access target designated in the access request, outputs to the disk controller a command for spinning up the spun-off disk, and sends response information to the host system to the effect that processing for accessing the access target is being performed until the spun-off disk is spun up.

4. The storage system according to claim 1,
wherein the primary controller sends, in response to the access request, response information to the effect that processing for accessing the access target is being performed until the disk device in the power saving status is returned to the accessible status.

5. The storage system according to claim 1,
wherein the primary controller stops sending the response information upon receiving information from the disk controller to the effect that the disk device in the power saving status has returned to the accessible status.

6. The storage system according to claim 1, further comprising:
a plurality of logical volumes configured from a logical storage area of the plurality of disk devices; and
a plurality of file systems including a file group that was hierarchized and created on the plurality of logical volumes;
wherein the disk controller spins up the rotation of each of the disks until each of the disk devices becomes the accessible status or spins off the rotation of each of the disks until each of the disk devices becomes the power saving status;
wherein the primary controller functions as a file server for managing the plurality of file systems by associating them with a plurality of shared folders;
the primary controller distinguishes an access request from a client terminal as the host system and, if the access request is a connection request to a shared folder belonging to any file system among the plurality of file systems, extracts an access-target file system designated in the access request among the plurality of file systems;
if a disk that was subject to the spin-off is included in a disk device corresponding to the extracted target file system, the primary controller outputs to the disk controller a command for spinning up the spun-off disk; and
the primary controller sends response information to a client terminal as the host system to the effect that connection processing is being performed to a shared folder belonging to the target file system.

7. An information processing method of a storage system comprising a plurality of disk devices for storing data, a disk controller for controlling the input and output of data to and from the plurality of disk devices and controlling the rotation of each disk as a constituent element of each of the disk devices so as to cause each of the disk devices to be in an accessible status or a power saving status, and a primary controller for sending and receiving information to and from a host system and the disk controller, and executing processing to the disk controller and each of the disk devices based on an access request from the host system;
wherein the primary controller executes:
a step of distinguishing an access request from the host system;
a step of outputting to the disk controller, if an access target designated in the access request includes a disk device in the power saving status, a command for returning the disk device in the power saving status to the accessible status; and
a step of sending response information to the host system to the effect that processing for accessing the access target is being performed in response to the access request.

8. The information processing method of a storage system according to claim 7,
wherein the storage system further comprises a plurality of logical volumes configured from a logical storage area of the plurality of disk devices, and a plurality of file systems including a file group that was hierarchized and created on the plurality of logical volumes;
wherein the disk controller executes a step of spinning up the rotation of each of the disks until each of the disk devices becomes the accessible status or spinning off the rotation of each of the disks until each of the disk devices becomes the power saving status; and
wherein the primary controller, as a file server for managing the plurality of file systems by associating them with a plurality of shared folders, executes:
a step of outputting to the disk controller, if a power saving-target file system exists in the plurality of file systems, a command for causing a disk device corresponding to the power saving-target file system to become the power saving status;
a step of saving tree information of the power saving-target file system;
a step of distinguishing an access request from a client terminal as the host system;
a step of extracting, if the access request is a connection request to a shared folder belonging to any file system among the plurality of file systems, an access-target file system designated in the access request among the plurality of file systems;
a step of outputting to the disk controller, if a disk that was subject to the spin-off is included in a disk device corresponding to the extracted target file system, a command for spinning up the spun-off disk;
a step of creating response information to the effect that connection processing is being performed to a shared folder belonging to the target file system based on the saved tree information;
a step of sending the created response information to a client terminal as the host system until the connection processing that is being performed to the shared folder belonging to the target file system is complete; and
a step of stopping the sending of the response information upon receiving information from the disk controller to the effect that the disk device in the power saving status has been returned to the accessible status.

9. The information processing method of a storage system according to claim 7,
wherein the disk controller executes a step of spinning up the rotation of each of the disks until each of the disk devices becomes the accessible status or spinning off the rotation of each of the disks until each of the disk devices becomes the power saving status; and
wherein the primary controller executes:
a step of distinguishing an access request from the host system;
a step of outputting to the disk controller, if a disk device containing a disk that was subject to the spin-off is included in an access target designated in the access request, a command for spinning up the spun-off disk; and
a step of sending response information to the host system to the effect that processing for accessing the access target is being performed until the spun-off disk is spun up.

10. The information processing method of a storage system according to claim 7,
wherein the primary controller executes a step of sending, in response to the access request, response information to the effect that processing for accessing the access target is being performed until the disk device in the power saving status is returned to the accessible status.

11. The information processing method of a storage system according to claim 7,
wherein the primary controller executes a step of stops the sending of the response information upon receiving information from the disk controller to the effect that the disk device in the power saving status has returned to the accessible status.

12. The information processing method of a storage system according to claim 7,
wherein the storage system further comprises a plurality of logical volumes configured from a logical storage area of the plurality of disk devices, and a plurality of file systems including a file group that was hierarchized and created on the plurality of logical volumes;
wherein the disk controller executes a step of spinning up the rotation of each of the disks until each of the disk devices becomes the accessible status or spinning off the rotation of each of the disks until each of the disk devices becomes the power saving status; and
wherein the primary controller, as a file server for managing the plurality of file systems by associating them with a plurality of shared folders, executes:
a step of distinguishing an access request from a client terminal as the host system;
a step of extracting, if the access request is a connection request to a shared folder belonging to any file system among the plurality of file systems, an access-target file system designated in the access request among the plurality of file systems;
a step of outputting to the disk controller, if a disk that was subject to the spin-off is included in a disk device corresponding to the extracted target file system, a command for spinning up the spun-off disk; and
a step of sending response information to a client terminal as the host system to the effect that connection processing is being performed to a shared folder belonging to the target file system.
